(19) United States
(12) Patent Application Publication
(10) Pub. No.: US 2021/0349591 A1
(43) Pub. Date: Nov. 11, 2021

(54) OBJECT PROCESSING METHOD AND TERMINAL DEVICE

(71) Applicant: VIVO MOBILE COMMUNICATION CO., LTD., Dongguan (CN)

(72) Inventor: Haochen LI, Dongguan (CN)

(73) Assignee: VIVO MOBILE COMMUNICATION CO., LTD., Dongguan (CN)

(21) Appl. No.: 17/383,434

(22) Filed: Jul. 23, 2021

Related U.S. Application Data
(63) Continuation of application No. PCT/CN2019/129861, filed on Dec. 30, 2019.

(30) Foreign Application Priority Data
Jan. 25, 2019 (CN) 201910074692.7

(51) Int. Cl. G06F 3/0487; G06F 3/0482; G06F 3/0484

(52) U.S. Cl. CPC G06F 3/0487; G06F 3/0484; G06F 3/0482

(57) ABSTRACT

Embodiments of the present disclosure provide an object processing method and a terminal device. The method includes: receiving a first input by a user, where the first input is a selection input for a target object in at least one first object displayed on the first screen; displaying the target object on the second screen in response to the first input; receiving a second input by the user for at least one second object displayed on the second screen, where the at least one second object includes the target object; and performing target processing on the at least one second object in response to the second input.

### CROSS-REFERENCE TO RELATED APPLICATIONS

This application is a bypass continuation of PCT Application No. PCT/CN2019/129861 filed Dec. 30, 2019, which claims priority to Chinese Patent Application No. 201910074692.7, filed with the China National Intellectual Property Administration on Jan. 25, 2019, both of which are incorporated herein by reference in their entireties.

### TECHNICAL FIELD

Embodiments of the present disclosure relate to the field of communications technologies, and in particular, to an object processing method and a terminal device.

### BACKGROUND

With the development of communications technologies, a memory capacity of a terminal device is increasingly large. Therefore, a user may store various files such as a photo, a document, and a video on the terminal device.

Currently, the user can perform a management operation on multiple files stored in the terminal device. A photo is used as an example of a file for example description. If an album of the terminal device includes a relatively large quantity of photos, a screen of the terminal device may not be able to display all the photos in the album at the same time. Therefore, the user may perform a sliding operation on the screen to trigger the terminal device to display the photos in the album in a scrolling manner, so that the user may select multiple photos from these photos, to perform a management operation such as deleting the multiple photos.

However, in the process of the foregoing management operation, if the user wants to change the selected photos, when the screen cannot simultaneously display the photos selected by the user, the user may perform the sliding operation on the screen again, to trigger the terminal device to display, in the scrolling manner, the photos selected by the user. In this way, the user can change the selected photos and perform the management operation on the changed photos. Consequently, the process of viewing and operating the file is cumbersome and time-consuming.

### SUMMARY

Embodiments of the present disclosure provide an object processing method and a terminal device, to resolve a problem that a process of viewing and operating a file is cumbersome and time-consuming.

To resolve the foregoing technical problem, the embodiments of the present disclosure are implemented as follows:

According to a first aspect, an embodiment of the present disclosure provides an object processing method, and the method is applied to a terminal device including a first screen and a second screen. The method includes: receiving a first input by a user, where the first input is a selection input for a target object in at least one first object displayed on the first screen; displaying the target object on the second screen in response to the first input; receiving a second input by the user for at least one second object displayed on the second screen, where the at least one second object includes the target object; and performing target processing on the at least one second object in response to the second input.

According to a second aspect, an embodiment of the present disclosure provides a terminal device, where the terminal device includes a first screen and a second screen, and the terminal device includes a receiving module, a displaying module, and a processing module. The receiving module is configured to receive a first input by a user, where the first input is a selection input for a target object in at least one first object displayed on the first screen. The displaying module is configured to display the target object on the second screen in response to the first input received by the receiving module. The receiving module is further configured to receive a second input by the user for at least one second object displayed on the second screen, where the at least one second object includes the target object. The processing module is configured to perform target processing on the at least one second object in response to the second input received by the receiving module.

According to a third aspect, an embodiment of the present disclosure further provides a terminal device, including a memory, a processor, and a computer program that is stored in the memory and can run on the processor, where when the computer program is executed by the processor, steps in the object processing method provided in the first aspect are implemented.

According to a fourth aspect, an embodiment of this application provides a computer- readable storage medium, where the computer-readable storage medium stores a computer program, and when the computer program is executed by a processor, steps of the object processing method provided in the first aspect are implemented.

In the embodiments of the present disclosure, a first input by a user may be received, where the first input is a selection input for a target object in at least one first object displayed on a first screen; the target object is displayed on a second screen in response to the first input; a second input by the user for at least one second object displayed on the second screen is received, where the at least one second object includes the target object; and target processing is performed on the at least one second object in response to the second input. In this solution, because the terminal device may display, on the second screen, an object selected by the user from multiple objects on the first screen, the user can perform change and management operations on one or more second objects on the second screen, and does not need to perform an up-and-down sliding operation on the first screen to trigger the terminal device to display, in a scrolling manner, objects selected by the user. Therefore, a process of viewing and operating a file may be simplified, and the user's time is saved.

### BRIEF DESCRIPTION OF DRAWINGS

FIG. 1 is a schematic architectural diagram of an Android operating system according to an embodiment of the present disclosure;

FIG. 2 is a schematic diagram of an object processing method according to an embodiment of the present disclosure;

FIG. 3 is a schematic diagram of an operation for a target object according to an embodiment of the present disclosure;

FIG. 4 is a schematic diagram of an operation for a second object according to an embodiment of the present disclosure;

FIG. 5 is a schematic diagram of another object processing method according to an embodiment of the present disclosure;

FIG. 6 is a schematic diagram of another object processing method according to an embodiment of the present disclosure;

FIG. 7 is a schematic diagram of displaying a third object by a terminal device according to an embodiment of the present disclosure;

FIG. 8 is a schematic diagram of another object processing method according to an embodiment of the present disclosure;

FIG. 9 is a schematic diagram of an operation by a user for a target control according to an embodiment of the present disclosure;

FIG. 10 is a schematic structural diagram of a terminal device according to an embodiment of the present disclosure; and

FIG. 11 is a schematic hardware diagram of a terminal device according to an embodiment of the present disclosure.

### DETAILED DESCRIPTION

The following clearly describes the technical solutions in the embodiments of the present disclosure with reference to the accompanying drawings in the embodiments of the present disclosure. Apparently, the described embodiments are some rather than all of the embodiments of the present disclosure. Based on the embodiments of the present disclosure, all other embodiments obtained by a person of ordinary skill in the art without creative efforts fall within the protection scope of the present disclosure.

In this specification, the term “and/or” is an association relationship that describes associated objects, and represents that there may be three relationships. For example, A and/or B may represent three cases: only A exists, both A and B exist, and only B exists. In this specification, the symbol “/” indicates that the associated objects are in an “or” relationship, for example, AB indicates A or B.

Terms “first”, “second”, and the like in the specification and claims of the present disclosure are used to distinguish between different objects, and are not used to describe a specific sequence of the objects. For example, a first input and a second input are used to distinguish between different inputs, and are not used to describe a specific sequence of input.

In the embodiments of the present disclosure, words such as “exemplary” or “for example” are used to indicate an example, an instance, or descriptions. Any embodiment or design scheme described as “exemplary” or “an example” in the embodiments of the present disclosure should not be construed as being advantageous over other embodiments or design schemes. Specifically, the words such as “exemplary” or “for example” are used to present related concepts in a specific manner.

In the descriptions of the embodiments of this disclosure, unless otherwise stated, “multiple” means two or more, for example, multiple elements mean two or more elements.

Embodiments of the present disclosure provide an object processing method and a terminal device. A first input by a user may be received, where the first input is a selection input for a target object in at least one first object displayed on a first screen; the target object is displayed on a second screen in response to the first input; a second input by the user for at least one second object displayed on the second screen is received, where the at least one second object includes the target object; and target processing is performed on the at least one second object in response to the second input. In this solution, because the terminal device may display, on the second screen, an object selected by the user from multiple objects on the first screen, the user can perform change and management operations on one or more second objects on the second screen, and does not need to perform an up-and-down sliding operation on the first screen to trigger the terminal device to display, in a scrolling manner, objects selected by the user. Therefore, a process of viewing and operating a file may be simplified, and the user's time is saved.

The terminal device in the embodiments of the present disclosure may be a terminal device with an operating system. The operating system may be an Android® operating system, may be an iOS® operating system, or may be another possible operating system. This is not specifically limited in the embodiments of the present disclosure.

The Android operating system is used as an example to describe a software environment to which an object processing method provided in an embodiment of the present disclosure is applied.

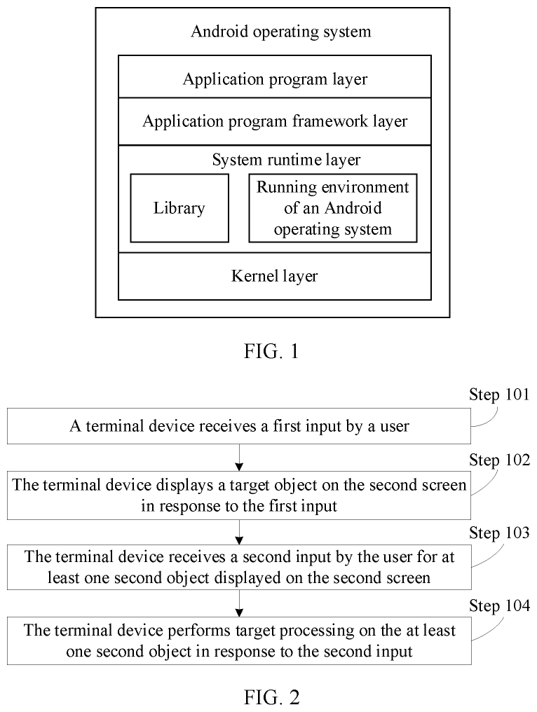

FIG. 1 is a schematic architectural diagram of an Android operating system according to an embodiment of the present disclosure. In FIG. 1, an architecture of the Android operating system includes four layers: an application program layer, an application program framework layer, a system runtime layer, and a kernel layer (which may be specifically a Linux kernel layer).

The application program layer includes various application programs in the Android operating system (including a system application program and a third-party application program).

The application program framework layer is a framework of an application program. A developer can develop some application programs based on the application program framework layer while complying with a development principle of the framework of the application program.

The system runtime layer includes a library (also referred to as a system library) and an operating environment of an Android operating system. The library mainly provides the Android operating system with various required resources. The operating environment of the Android operating system is used to provide a software environment for the Android operating system.

The kernel layer is an operating system layer of the Android operating system, and is a bottom layer in Android operating system software layers. The kernel layer provides a core system service and a hardware-related driver for the Android operating system based on a Linux kernel.

The Android operating system is used as an example. In the embodiments of the present disclosure, the developer may develop, based on the foregoing system architecture of the Android operating system shown in FIG. 1, a software program for implementing the object processing method provided in the embodiments of the present disclosure, so that the object processing method may run based on the Android operating system shown in FIG. 1. In other words, a processor or a terminal device may run the software program in the Android operating system to implement the object processing method provided in the embodiments of the present disclosure.

The terminal device in the embodiments of the present disclosure may be a mobile terminal device, or may be a non-mobile terminal device. For example, the mobile terminal device may be a mobile phone, a tablet computer, a notebook computer, a palmtop computer, an in-vehicle terminal device, a wearable device, an ultra-mobile personal computer (UMPC), a netbook, or a personal digital assistant (PDA), and the non-mobile terminal device may be a personal computer (PC), a television (TV), a counter, or a self-service computer. This is not specifically limited in the embodiments of the present disclosure.

The object processing method provided in the embodiments of the present disclosure may be performed by the foregoing terminal device or a functional module and/or a functional entity that can implement the object processing method in the terminal device. Specifically, this may be determined according to an actual use requirement, and is not limited in the embodiments of the present disclosure. The terminal device is used as an example below to describe the object processing method provided in the embodiments of the present disclosure.

As shown in FIG. 2, an embodiment of the present disclosure provides an object processing method. The method may be applied to a terminal device including a first screen and a second screen. The method may include the following step 101 to step 104.

Step 101: The terminal device receives a first input by a user.

The first input may be selection input for a target object in at least one first object displayed on the first screen.

In this embodiment of the present disclosure, if the user wants to perform a management operation on multiple files stored in the terminal device, the user may trigger the terminal device to display the at least one first object on the first screen, where each first object in the at least one first object may be used to indicate one file; and select the target object from the at least one first object. Therefore, the terminal device may receive input by the user to select the target object, namely, the first input.

Optionally, in this embodiment of the present disclosure, content indicated by each of the at least one first object may be any one of the following: an image, a video, audio, a document, or an application program.

For example, if content indicated by the first object is an image, the first object may be a thumbnail of the image; if content indicated by the first object is a video, the first object may be a thumbnail of any frame of image of the video; if content indicated by the first object is audio, the first object may be an image, text, an identifier, or the like; if content indicated by the first object is a document, the first object may be an image, text, an identifier, or the like; or if content indicated by the first object is an application program, the first object may be an icon, text, or the like of the application program.

It may be understood that, in this embodiment of the present disclosure, multiple first objects that are used to indicate an image, a video, audio, a document, an application program, and the like are displayed on the first screen of the terminal device, so that the user can perform a management operation on the image, the video, the audio, the document, the application program, and the like in a unified manner.

Optionally, in this embodiment of the present disclosure, the first input may be at least one of a touch input, a gravity input, a key input, or the like. Specifically, the touch input may be a touch and hold input, a sliding input, or a tapping input performed by the user on a touch screen of the terminal device; the gravity input may be that the user shakes the terminal device in a specific direction, the user shakes the terminal device for a specific quantity of times, or the like; and the key input may be a tapping input, a double-tapping input, a touch and hold input, or a combination key input performed by the user on a key of the terminal device.

Optionally, in this embodiment of the present disclosure, the first screen and the second screen of the terminal device may be two independent screens, and the first screen and the second screen may be connected by an axis, a chain, or the like. Alternatively, a screen of the terminal device may be a flexible screen, and the flexible screen may be folded into at least two parts, for example, is folded into the first screen and the second screen. This may be specifically determined according to an actual use requirement, and is not limited in this embodiment of the present disclosure.

It should be noted that an example in which the terminal device includes two screens is used as an example for description in this embodiment of the present disclosure, and constitutes no limitation to this embodiment of the present disclosure. It may be understood that, in actual implementation, the terminal device may include three or more screens. This may be specifically determined according to an actual use requirement.

Step 102: The terminal device displays the target object on the second screen in response to the first input.

Optionally, in this embodiment of the present disclosure, the second screen of the terminal device may include a first region and a second region. The first region may be used to display an object selected by the user, and the second region may be used to display at least one management operation control.

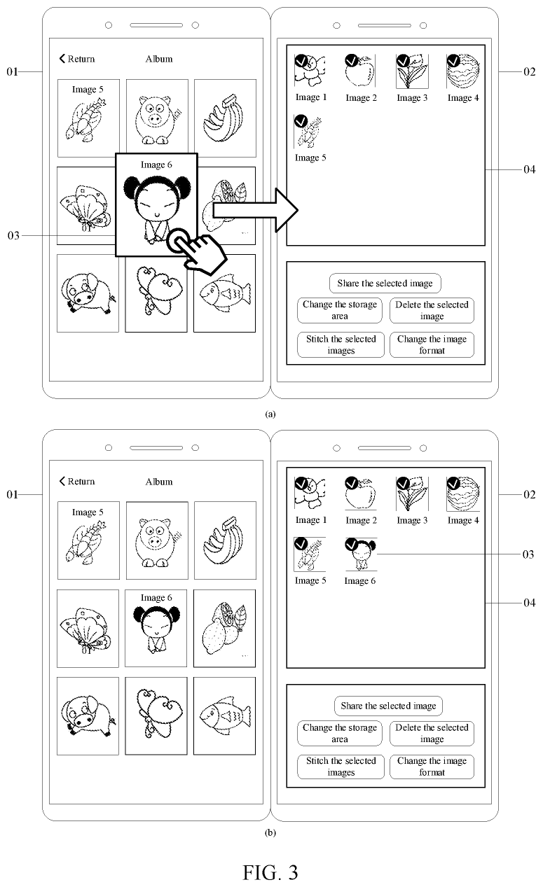

For example, an example in which the at least one first object is multiple photos in an album and the first input is a touch input by the user for one photo in the multiple photos is used for description. As shown in (a) in FIG. 3, if the user wants to perform a management operation on a photo in the album, the user may trigger the terminal device to open the album, and thumbnails of photos in the album are displayed on the first screen 01, so that the user may select and input “image 1”, “image 2”, “image 3”, “image 4”, “image 5”, “image 6”, and the like in the album. For example, if the user performs a press operation on an “image 6” 03 on the first screen 01, as shown in (b) in FIG. 3, the terminal device may receive selection input by the user for the “image 6” 03, namely, the first input, and in response to the first input, display the “image 6” in the first region 04 of the second screen 02, in other words, display the “image 6” 03 on the second screen.

Optionally, in this embodiment of the present disclosure, the terminal device may display the target object on the second screen according to a preset display ratio.

For example, assuming that the terminal device displays the target object on the first screen based on a first display ratio, the preset display ratio may be less than the first display ratio, in other words, a display size of the target object on the second screen is smaller than a display size of the first screen; or the preset display ratio may be equal to the first display ratio, in other words, a display size of the target object on the second screen is equal to a display size of the first screen; or the preset display ratio may be greater than the first display ratio, in other words, a display size of the target object on the second screen is greater than a display size of the first screen. This may be specifically determined according to an actual use requirement, and is not limited in this embodiment of the present disclosure.

Step 103: The terminal device receives a second input by the user for at least one second object displayed on the second screen.

The at least one second object may include the target object.

Optionally, in this embodiment of the present disclosure, in an optional implementation, the at least one second object may be an object selected by the user from the objects displayed on the first screen; and in another optional implementation, if a quantity of the at least one second object is multiple, the target object may be an object selected by the user from the objects displayed on the first screen, and an object other than the target object in the at least one second object may be an object selected from the objects displayed on the second screen.

In this embodiment of the present disclosure, assuming that the second screen of the terminal device includes M second objects, a quantity of the at least one second object may be N, and the at least one second object may be an object in the M second objects. Specifically, when N=M, the at least one second object is the M second objects; and when N<M, the at least one second object is some objects in the M second objects. M and N are each a positive integer.

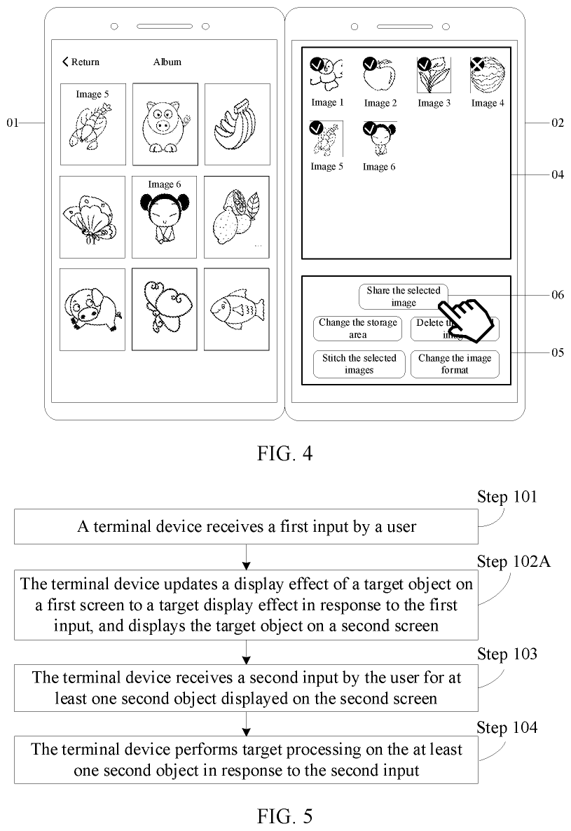

For example, as shown in FIG. 3, the second screen 02 of the terminal device may include six images selected by the user from the first screen: “image 1”, “image 2”, “image 3”, “image 4”, “image 5”, and “image 6”, and the six images may be in a selected state. As shown in FIG. 4, if the user wants to change the selected state of the “image 4” to an unselected state, in other words, the user wants to change the selected image, the user may tap the “image 4”, so that the terminal device may change the selected state of the “image 4” to the unselected state. If the user taps a “share the selected image” control 06 in the second region 05 of the second screen 02, the terminal device may send “image 1, “image 2”, “image 3”, “image 4”, and “image 5” to a target device.

Optionally, in this embodiment of the present disclosure, content indicated by the at least one second object may be any one of the following: an image, a video, audio, a document, an application program, or an installation package of an application program. For example, if the content indicated by the second object is an image, the second object may be a thumbnail of the image; if the content indicated by the second object is a video, the second object may be a thumbnail of any frame of image of the video; if the content indicated by the second object is audio, the second object may be a thumbnail, text, an identifier, or the like; if the content indicated by the second object is a document, the second object may be a thumbnail, text, an identifier, or the like; or if the content indicated by the first object is an application program or an installation package of an application program, the second object may be an icon, text, or the like of the application program.

Optionally, in this embodiment of the present disclosure, the second input may be at least one of a touch input, a gravity input, a key input, or the like. Specifically, the touch input may be a touch and hold input, a sliding input, or a tapping input performed by the user on a touch screen of the terminal device; the gravity input may be that the user shakes the terminal device in a specific direction, the user shakes the terminal device for a specific quantity of times, or the like; and the key input may be a tapping input, a double-tapping input, a touch and hold input, or a combination key input performed by the user on a key of the terminal device.

Step 104: The terminal device performs target processing on the at least one second object in response to the second input.

Optionally, in this embodiment of the present disclosure, the performing target processing on the at least one second object may include any one of the following: sending the at least one first object to the target device, sending the content indicated by the at least one first object to the target device, deleting the at least one first object from the terminal device, deleting the content indicated by the at least one first object from the terminal device, changing a file format of the at least one first object, changing a file format of the content indicated by the at least one first object, changing a storage area of the at least one first object to a target storage area, changing a storage area of the content indicated by the at least one first object to a target storage area, merging the at least one first object into one object, or merging the content indicated by the at least one first object into one piece of content.

Optionally, in this embodiment of the present disclosure, the target device may be a server or another terminal device.

Optionally, if the content indicated by the at least one second object is any one of the following: an image, a video, audio, or a document, the performing target processing on the at least one second object may include any one of the following (1) to (10).

(1) Send the at least one second object to the target device.

For example, when the at least one second object is S thumbnails, the terminal device may send the S thumbnails to the target device. Content indicated by the S thumbnails may be S images, S videos, S pieces of audio, or S documents. S is a positive integer.

(2) Send the content indicated by the at least one second object to the target device.

For example, an example in which a quantity of the at least one second object is S is used for description. If the content indicated by the at least one second object is S images, the terminal device may send the S images to the target device. If the content indicated by the at least one second object is S videos, the terminal device may send the S videos to the target device. If the content indicated by the at least one second object is S pieces of audio, the terminal device may send the S pieces of audio to the target device. If the content indicated by the at least one second object is S documents, the terminal device may send the S documents to the target device.

(3) Delete the at least one second object from the terminal device.

For example, when the at least one second object is S thumbnails, the terminal device may delete the S thumbnails from the terminal device. Content indicated by the S thumbnails may be S images, S videos, S pieces of audio, or S documents.

(4) Delete the content indicated by the at least one second object from the terminal device.

For example, an example in which a quantity of the at least one second object is S is used for description. If the content indicated by the at least one second object is S images, the terminal device may delete the S images. If the content indicated by the at least one second object is S videos, the terminal device may delete the S videos. If the content indicated by the at least one second object is S pieces of audio, the terminal device may delete the S pieces of audio. If the content indicated by the at least one second object is S documents, the terminal device may delete the S documents.

(5) Change a file format of the at least one second object.

For example, when the at least one second object is S thumbnails, the terminal device may change file formats of the S thumbnails. Content indicated by the S thumbnails may be S images, S videos, S pieces of audio, or S documents.

(6) Change a file format of the content indicated by the at least one second object.

For example, an example in which a quantity of the at least one second object is S is used for description. If the content indicated by the at least one second object is S images, the terminal device may change file formats of the S images. If the content indicated by the at least one second object is S videos, the terminal device may change file formats of the S videos. If the content indicated by the at least one second object is S pieces of audio, the terminal device may change file formats of the S pieces of audio. If the content indicated by the at least one second object is S documents, the terminal device may change file formats of the S documents.

(7) Change a storage area of the at least one second object to a target storage area.

For example, when the at least one second object is S thumbnails, the terminal device may change storage areas of the S thumbnails to the target storage area. Content indicated by the S thumbnails may be S images, S videos, S pieces of audio, or S documents.

(8) Change a storage area of the content indicated by the at least one second object to a target storage area.

For example, an example in which a quantity of the at least one second object is S is used for description. If the content indicated by the at least one second object is S images, the terminal device may change storage areas of the S images to the target storage area. If the content indicated by the at least one second object is S videos, the terminal device may change storage areas of the S videos to the target storage area. If the content indicated by the at least one second object is S pieces of audio, the terminal device may change storage areas of the S pieces of audio to the target storage area. If the content indicated by the at least one second object is S documents, the terminal device may change storage areas of the S documents to the target storage area.

(9) Merge the at least one second object into one object.

For example, when the at least one second object is S thumbnails, the terminal device may merge the S thumbnails into one object. Content indicated by the S thumbnails may be S images, S videos, S pieces of audio, or S documents.

(10) Merge the content indicated by the at least one second object into one piece of content. For example, an example in which a quantity of the at least one second object is S is

used for description. If the content indicated by the at least one second object is S images, the terminal device may merge the S images into one image. If the content indicated by the at least one second object is S videos, the terminal device may merge the S videos into one video. If the content indicated by the at least one second object is S pieces of audio, the terminal device may merge the S pieces of audio into one audio. If the content indicated by the at least one second object is S documents, the terminal device may merge the S documents into one document.

Optionally, if the content indicated by the at least one second object is an application program, the performing target processing on the at least one second object may include any one of the following (1) to (4).

(1) Delete the at least one second object from the terminal device.

For example, when the at least one second object is S application icons, the terminal device may delete the S application icons from the terminal device. Content indicated by the S application icons may be S application programs.

(2) Delete the content indicated by the at least one second object from the terminal device.

For example, when the content indicated by the at least one second object is S application programs, the terminal device may delete the S application programs from the terminal device.

(3) Change a storage area of the at least one second object to a target storage area.

For example, when the at least one second object is S application icons, the terminal device may change storage areas of the S application icons to the target storage area. Content indicated by the S application icons may be S application programs.

(4) Change a storage area of the content indicated by the at least one second object to a target storage area.

For example, when the content indicated by the at least one second object is S application programs, the terminal device may change storage areas of the S application programs to the target storage area.

Optionally, if the content indicated by the at least one second object is an installation package of an application program, the performing target processing on the at least one second object may include any one of the following (1) to (7).

(1) Send the content indicated by the at least one second object to the target device.

For example, when the at least one second object is S application icons, the terminal device may send the S application icons to the target device. Content indicated by the S application icons may be installation packages of S application programs.

(2) Delete the at least one second object from the terminal device.

For example, when the at least one second object is S application icons, the terminal device may delete the S application icons from the terminal device.

(3) Delete the content indicated by the at least one second object from the terminal device.

For example, when the content indicated by the at least one second object is installation packages of S application programs, the terminal device may delete the installation packages of the S application programs from the terminal device.

(4) Change a file format of the content indicated by the at least one second object.

For example, when the content indicated by the at least one second object is installation packages of S application programs, the terminal device may change file formats of the installation packages of the S application programs.

(5) Change a storage area of the at least one second object to a target storage area.

For example, when the at least one second object is S application icons, the terminal device may change storage areas of the S application icons to the target storage area. Content indicated by the S application icons may be installation packages of S application programs.

(6) Change a storage area of the content indicated by the at least one second object to a target storage area.

For example, when the content indicated by the at least one second object is installation packages of S application programs, the terminal device may change storage areas of the installation packages of the S application programs to the target storage area.

(7) Merge the content indicated by the at least one second object into one piece of content.

For example, when the content indicated by the at least one second object is installation packages of S application programs, the terminal device may merge the installation packages of the S application programs into one installation package.

In the object processing method provided in this embodiment of the present disclosure, because the terminal device may display, on the second screen, an object selected by the user from multiple objects on the first screen, the user may perform change and management operations on the selected object on the second screen, and does not need to perform an up-and-down sliding operation on the first screen to trigger the terminal device to display, in a scrolling manner, the object selected by the user, so that a process of viewing and operating a file may be simplified, and the user's time is saved.

Optionally, with reference to FIG. 2, as shown in FIG. 5, in this embodiment of the present disclosure, before displaying the target object on the second screen, the terminal device may update a display effect of the target object on the first screen to a target display effect. Specifically, the foregoing step 102 may be implemented by using the following step 102A.

Step 102A: The terminal device updates a display effect of the target object on the first screen to a target display effect in response to the first input, and displays the target object on the second screen.

It should be noted that, for specific descriptions of the target object, reference may be made to related descriptions of the target object in step 101 in the foregoing embodiment. Details are not described herein again.

Optionally, in this embodiment of the present disclosure, the foregoing target display effect may be magnifying and displaying the target object, displaying the target image in a preset color, displaying the target image in transparency, flashing and displaying the target image, displaying the target image in a floating manner, or displaying a preset identifier such as a dashed-line box on the target object. Certainly, the target display effect may further include another possible display effect. This is not specifically limited in this embodiment of the present disclosure.

Optionally, in this embodiment of the present disclosure, the first input may include first sub-input and second sub-input. The first sub-input may be the pressing input by the user for the target object, and the second sub-input may be the sliding input for the target object.

For example, the foregoing FIG. 3 is still used as an example for description. As shown in (a) in FIG. 3, the user may perform pressing input on the “image 6” 03 on the first screen 01, so that the terminal device may receive the pressing input by the user for the “image 6” 03, namely, the first sub-input, and magnify and display the “image 6” 03 in response to the first sub-input. Optionally, if the user presses and slides the “image 6” 03 towards the second screen, the terminal device may receive sliding input for the “image 6” 03, namely, the second sub-input, and as shown in (b) in FIG. 3, the terminal device may display the “image 6” 03 on the second screen 04 in response to the second sub-input, in other words, display the target object on the second screen.

According to the object processing method provided in this embodiment of the present disclosure, the target image is displayed by using the target display effect, so that the user can know that the target image is selected, thereby facilitating the user in performing another operation.

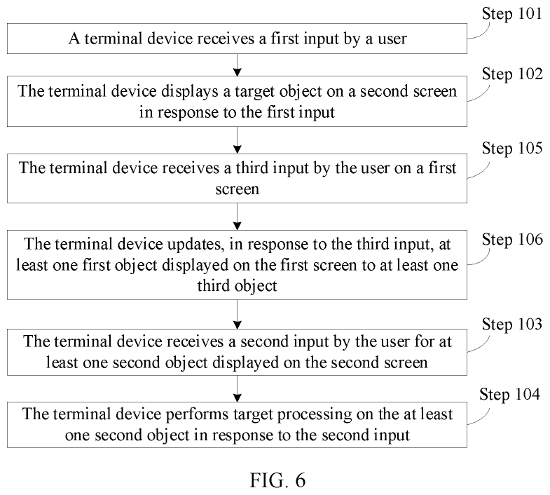

Optionally, with reference to FIG. 2, as shown in FIG. 6, the object processing method provided in this embodiment of the present disclosure may further include the following step 105 and step 106.

Step 105: The terminal device receives a third input by the user on the first screen.

Step 106: The terminal device updates, in response to the third input, the at least one first object displayed on the first screen to at least one third object.

It should be noted that, in this embodiment of the present disclosure, the at least one first object and the at least one third object may be completely different, or may be partially different. This may be specifically determined according to an actual use requirement, and is not limited in this embodiment of the present disclosure.

In addition, in FIG. 6, for example, the terminal device performs step 101 and step 102 first, and then performs step 105 and step 106. This composes no limitation to this embodiment of the present disclosure. It may be understood that, in actual implementation, the terminal device may perform step 105 and step 106 first, and then perform step 101 to step 104; or the terminal device may perform step 101 to step 104 first, and then perform step 105 and step 106. This may be specifically determined according to an actual use requirement.

Optionally, in this embodiment of the present disclosure, the third input may be a touch and hold input, a sliding input, a tapping input, or the like. This may be specifically determined according to an actual use requirement, and is not limited in this embodiment of the present disclosure.

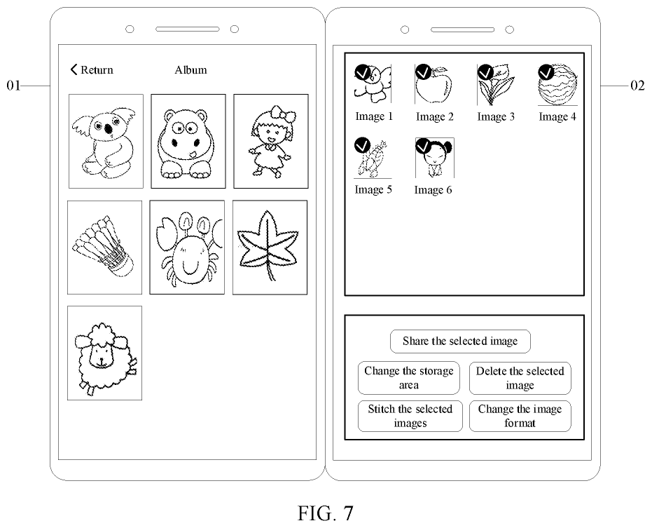

For example, FIG. 7 is a schematic diagram of displaying a third object by a terminal device according to an embodiment of the present disclosure. The foregoing FIG. 3 is an example for description. Assuming that an image displayed on the first screen in FIG. 3 is a first object, after the user selects “image 6” from the first screen, the user may slide down or up on the first screen. In this way, the terminal device may receive the sliding input by the user, namely, a fourth input, and update, in response to the fourth input, the first object displayed on the first screen shown in FIG. 3 to the second object displayed on the first screen shown in FIG. 7, in other words, the terminal device may update the at least one first object displayed on the first screen to the at least one third object.

According to the object processing method provided in this embodiment of the present disclosure, the user may trigger, according to an actual use requirement, the terminal device to display the at least one third object. Therefore, the user may select, from the third object, another object that is different from the target object, to trigger the terminal device to display a selected object on the second screen.

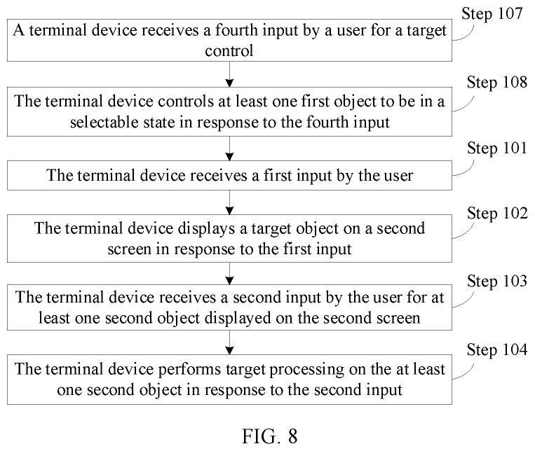

Optionally, with reference to FIG. 2, as shown in FIG. 8, the first screen may further display a target control. Before the foregoing step 101, the object processing method provided in this embodiment of the present disclosure may further include the following step 107 and step 108.

Step 107: The terminal device receives a fourth input by the user for the target control.

Step 108: The terminal device controls at least one first object to be in a selectable state in response to the fourth input.

Optionally, in this embodiment of the present disclosure, the fourth input may be a touch and hold input, a sliding input, a tapping input, or the like for the target control. This may be specifically determined according to an actual use requirement, and is not limited in this embodiment of the present disclosure.

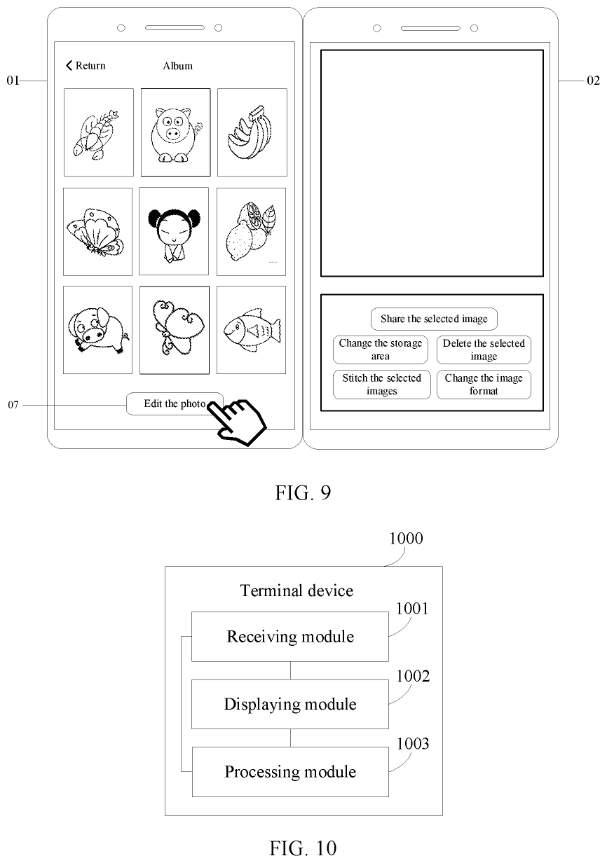

For example, FIG. 9 is a schematic diagram of an operation by a user for a target control according to an embodiment of the present disclosure. Assuming that the target control is an “edit the photo” 07 shown in FIG. 9, before the user moves the object on the first screen to the second screen, the user may first tap the “edit the photo” 07. In this way, the terminal device receives input by the user for the “edit the photo” 07, namely, the fourth input, and in response to the fourth input, controls at least one first object to be in a selectable state. Optionally, when the at least one first object is in the selectable state, the user may select six images: “image 1”, “image 2”, “image 3”, “image 4”, “image 5”, and “image 6” shown in FIG. 3.

According to the object processing method provided in this embodiment of the present disclosure, because the first object on the first screen may be in the selectable state by using input for the control, the user may select one or more objects from the first object.

It should be noted that, the foregoing FIG. 5, FIG. 6, and FIG. 8 in the embodiments of the present disclosure are described by using an example with reference to FIG. 2, and this composes no limitation to this embodiment of the present disclosure. It may be understood that, in actual implementation, FIG. 5, FIG. 6, and FIG. 8 may be further implemented with reference to any other accompanying drawings.

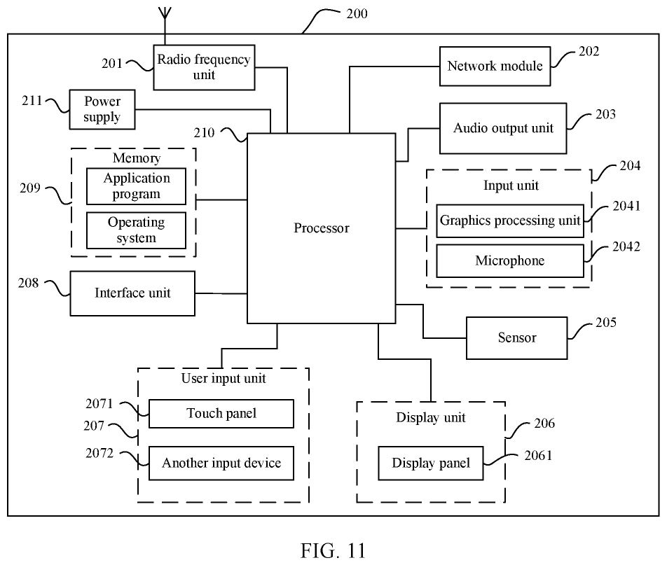

As shown in FIG. 10, an embodiment of the present disclosure provides a terminal device 1000. The terminal device includes a first screen and a second screen. The terminal device may include a receiving module 1001, a displaying module 1002, and a processing module 1003. The receiving module 1001 may be configured to receive a first input by a user, where the first input is a selection input for a target object in at least one first object displayed on the first screen. The displaying module 1002 may be configured to display the target object on the second screen in response to the first input received by the receiving module 1001. The receiving module 1001 may be further configured to receive a second input by the user for at least one second object displayed on the second screen, where the at least one second object includes the target object. The processing module 1003 may be configured to perform target processing on the at least one second object in response to the second input received by the receiving module 1001.

Optionally, in this embodiment of the present disclosure, content indicated by each first object may be any one of the following: an image, a video, audio, a document, or an application program.

Optionally, in this embodiment of the present disclosure, content indicated by the at least one second object may be any one of the following: an image, a video, audio, or a document. The processing module 1003 may be specifically configured to: send the at least one first object to a target device; or send the content indicated by the at least one first object to a target device; or delete the at least one first object from the terminal device; or delete the content indicated by the at least one first object from the terminal device; or change a file format of the at least one first object; or change a file format of the content indicated by the at least one first object; or change a storage area of the at least one first object into a target storage area; or change a storage area of the content indicated by the at least one first object into a target storage area; or merge the at least one first object into one object; or merge the content indicated by the at least one first object into one piece of content.

Optionally, in this embodiment of the present disclosure, the content indicated by the at least one second object is an application program. The processing module 1003 may be specifically configured to: delete the at least one second object from the terminal device; or delete the content indicated by the at least one second object from the terminal device; or change a storage area of the at least one second object to a target storage area; or change a storage area of the content indicated by the at least one second object to a target storage area.

Optionally, in this embodiment of the present disclosure, the content indicated by the at least one second object is an application program. The processing module 1003 may be specifically configured to: send the content indicated by the at least one second object to a target device; or delete the at least one second object from the terminal device; or delete the content indicated by the at least one second object from the terminal device; or change a file format of the content indicated by the at least one second object; or change a storage area of the at least one second object to a target storage area; or change a storage area of the content indicated by the at least one second object to a target storage area; or merge the content indicated by the at least one second object into one piece of content.

Optionally, in this embodiment of the present disclosure, the displaying module 1002 may be further configured to: before displaying the target object on the second screen, update a display effect of the target object on the first screen to a target display effect.

Optionally, in this embodiment of the present disclosure, the receiving module 1001 may be further configured to receive a third input by the user on the first screen. The displaying module 1002 may be further configured to update, in response to the third input received by the receiving module 1001, the at least one first object displayed on the first screen to at least one third object.

Optionally, in this embodiment of the present disclosure, a target control is further displayed on the first screen. The receiving module 1001 may be further configured to: before receiving the first input, receive a fourth input by the user for the target control. The processing module 1003 may be further configured to control the at least one first object to be in a selectable state in response to the fourth input received by the receiving module 1001.

The terminal device provided in this embodiment of the present disclosure can implement processes implemented by the terminal device in the foregoing method embodiments. To avoid repetition, details are not described herein again.

This embodiment of the present disclosure provides a terminal device, because the terminal device may display, on the second screen, an object selected by the user from multiple objects on the first screen, the user may perform change and management operations on one or more second objects on the second screen, and does not need to perform an up-and-down sliding operation on the first screen to trigger the terminal device to display, in a scrolling manner, objects selected by the user, so that the terminal device provided in this embodiment of the present disclosure can simplify a process of viewing and operating a file, and the user's time is saved.

FIG. 11 is a schematic diagram of a hardware structure of a terminal device according to an embodiment of the present disclosure. As shown in FIG. 11, a terminal device 200 includes but is not limited to components such as a radio frequency unit 201, a network module 202, an audio output unit 203, an input unit 204, a sensor 205, a display unit 206, a user input unit 207, an interface unit 208, a memory 209, a processor 210, and a power supply 211. A person skilled in the art may understand that a structure of the terminal device shown in FIG. 11 does not constitute a limitation on the terminal device, and the terminal device may include more or fewer components than those shown in the figure, or merge some components, or have different component arrangements. In this embodiment of the present disclosure, the terminal device includes but is not limited to a mobile phone, a tablet computer, a notebook computer, a palmtop computer, an in- vehicle terminal device, a wearable device, a pedometer, and the like.

The user input unit 207 may be configured to receive a first input by a user, where the first input is a selection input for a target object in at least one first object displayed on a first screen. The display unit 206 may be configured to display the target object on the second screen in response to the first input received by the user input unit 207. The user input unit 207 may be further configured to receive a second input by the user for at least one second object displayed on a second screen, where the at least one second object includes the target object. The processor 210 may be configured to perform target processing on the at least one second object in response to the second input received by the user input unit 207.

This embodiment of the present disclosure provides a terminal device, because the terminal device may display, on the second screen, an object selected by the user from multiple objects on the first screen, the user may perform change and management operations on one or more second objects on the second screen, and does not need to perform an up-and-down sliding operation on the first screen to trigger the terminal device to display, in a scrolling manner, objects selected by the user, so that the terminal device provided in this embodiment of the present disclosure can simplify a process of viewing and operating a file, and the user's time is saved.

It should be understood that, in this embodiment of the present disclosure, the radio frequency unit 201 may be configured to receive and send information or receive and send a signal in a call process. Specifically, after downlink data from a base station is received, the processor 210 processes the downlink data. In addition, uplink data is sent to the base station. Generally, the radio frequency unit 201 includes but is not limited to an antenna, at least one amplifier, a transceiver, a coupler, a low noise amplifier, a duplexer, and the like. In addition, the radio frequency unit 201 may further communicate with a network and another device by using a wireless communication system.

The terminal device provides wireless broadband Internet access for the user by using the network module 202, for example, helping the user send and receive an email, browse a web page, and access streaming media.

The audio output unit 203 may convert audio data received by the radio frequency unit 201 or the network module 202 or stored in the memory 209 into an audio signal and output as sound. In addition, the audio output unit 203 may further provide audio output (for example, call signal receiving sound or message receiving sound) related to a specific function performed by the terminal device 200. The audio output unit 203 includes a loudspeaker, a buzzer, a telephone receiver, and the like.

The input unit 204 is configured to receive an audio or video signal. The input unit 204 may include a graphics processing unit (GPU) 2041 and a microphone 2042. The graphics processing unit 2041 processes image data of a static image or a video obtained by an image capturing apparatus (such as a camera) in a video capturing mode or an image capturing mode. A processed image frame may be displayed on the display unit 206. The image frame processed by the graphics processing unit 2041 may be stored in the memory 209 (or another storage medium) or sent by using the radio frequency unit 201 or the network module 202. The microphone 2042 may receive sound and can process such sound into audio data. The processed audio data may be output by being converted into a format that may be sent to a mobile communications base station by using the radio frequency unit 201 in a telephone call mode.

The terminal device 200 further includes at least one sensor 205, such as an optical sensor, a motion sensor, and another sensor. Specifically, the optical sensor includes an ambient light sensor and a proximity sensor. The ambient light sensor may adjust luminance of a display panel 2061 based on brightness of ambient light, and the proximity sensor may disable the display panel 2061 and/or backlight when the terminal device 200 approaches an ear. As a type of the motion sensor, an accelerometer sensor may detect magnitude of an acceleration in each direction (generally three axes), and may detect magnitude and a direction of gravity when being static. The accelerometer sensor may be used for recognizing a terminal device gesture (for example, horizontal and vertical screen switching, a related game, or magnetometer posture calibration), a function related to vibration recognition (for example, a pedometer or a strike), or the like. The sensor 205 may further include a fingerprint sensor, a pressure sensor, an iris sensor, a molecular sensor, a gyroscope, a barometer, a hygrometer, a thermometer, an infrared sensor, and the like. This is not described herein.

The display unit 206 is configured to display information entered by the user or information provided for the user. The display unit 206 may include a display panel 2061, and the display panel 2061 may be configured in a form of a liquid crystal display (LCD), an organic light- emitting diode (OLED), or the like.

The user input unit 207 may be configured to receive input digit or character information and generate key signal input related to user setting and function control of the terminal device. Specifically, the user input unit 207 includes a touch panel 2071 and another input device 2072. The touch panel 2071, also referred to as a touchscreen, may collect a touch operation performed by the user on or near the touch panel 2071 (for example, an operation performed by the user on or near the touch panel 2071 by using any suitable object or accessory such as a finger or a stylus). The touch panel 2071 may include two parts: a touch detection apparatus and a touch controller. The touch detection apparatus detects a touch position of the user, detects a signal brought by the touch operation, and transmits the signal to the touch controller. The touch controller receives touch information from the touch detection apparatus, converts the touch information into contact coordinates, sends the contact coordinates to the processor 210, and can receive and execute a command sent by the processor 210. In addition, the touch panel 2071 may be implemented by using multiple types such as a resistive type, a capacitive type, an infrared ray, and a surface acoustic wave. The user input unit 207 may include another input device 2072 in addition to the touch panel 2071. Specifically, the another input device 2072 may include but is not limited to one or more of a physical keyboard, a function key (such as a volume control key or an on/off key), a trackball, a mouse, a joystick, and the like. Details are not described herein.

Optionally, the touch panel 2071 may cover the display panel 2061. After detecting the touch operation on or near the touch panel 2071, the touch panel 2071 transmits the touch operation to the processor 210 to determine a type of a touch event, and then the processor 210 provides corresponding visual output on the display panel 2061 based on the type of the touch event. In FIG. 11, the touch panel 2071 and the display panel 2061 are used as two independent components to implement input and output functions of the terminal device. However, in some embodiments, the touch panel 2071 and the display panel 2061 may be integrated to implement the input and output functions of the terminal device. This is not specifically limited herein.

The interface unit 208 is an interface connecting an external apparatus to the terminal device 200. For example, the external apparatus may include a wired or wireless headset port, an external power supply (or battery charger) port, a wired or wireless data port, a storage card port, a port configured to connect to an apparatus having an identification module, an audio input/output (I/O) port, a video I/O port, a headset port, and the like. The interface unit 208 may be configured to receive input (for example, data information and power) from the external apparatus and transmit the received input to one or more elements in the terminal device 200, or may be configured to transmit data between the terminal device 200 and the external apparatus.

The memory 209 may be configured to store a software program and various data. The memory 209 may mainly include a program storage area and a data storage area. The program storage area may store an operating system, an application program required by at least one function (such as a sound play function or an image play function), and the like. The data storage area may store data (such as audio data or an address book) or the like created based on use of the mobile phone. In addition, the memory 209 may include a high-speed random access memory, and may further include a non-volatile memory such as at least one magnetic disk storage component, a flash memory component, or another volatile solid-state storage component.

The processor 210 is a control center of the terminal device, and is connected to all parts of the entire terminal device by using various interfaces and lines, and performs various functions of the terminal device and processes data by running or executing the software program and/or the module that are stored in the memory 209 and invoking the data stored in the memory 209, to implement overall monitoring on the terminal device. The processor 210 may include one or more processing units. Optionally, the processor 210 may be integrated with an application processor and a modem processor. The application processor mainly processes an operating system, a user interface, an application program, and the like, and the modem processor mainly processes wireless communication. It may be understood that the modem processor may also not be integrated into the processor 210.

The terminal device 200 may further include the power supply 211 (such as a battery) that supplies power to each component. Optionally, the power supply 211 may be logically connected to the processor 210 by using a power management system, to implement functions such as charging, discharging, and power consumption management by using the power management system.

In addition, the terminal device 200 includes some function modules not shown, and details are not described herein.

Optionally, an embodiment of the present disclosure further provides a terminal device, including, as shown in FIG. 11, a processor 210, a memory 209, and a computer program that is stored in the memory 209 and may run on the processor 210. When the computer program is executed by the processor 210, processes of the foregoing method embodiments can be implemented, and a same technical effect can be achieved. To avoid repetition, details are not described herein.

An embodiment of the present disclosure further provides a computer-readable storage medium. A computer program is stored in the computer-readable storage medium. When being executed by a processor, processes of the foregoing method embodiments can be implemented, and a same technical effect can be achieved. To avoid repetition, details are not described herein. The computer-readable storage medium includes a read-only memory (ROM), a random access memory (RAM), a magnetic disk, an optical disc, or the like.

It should be noted that in this specification, the term “include”, “including”, or any other variant is intended to cover non-exclusive inclusion, so that a process, method, article, or apparatus that includes a series of elements includes not only those elements but also other elements that are not explicitly listed, or includes elements inherent to such a process, method, article, or apparatus. In the absence of more restrictions, an element defined by the statement “including a . . . ” does not exclude another same element in a process, method, article, or apparatus that includes the element.

According to the descriptions of the foregoing implementations, a person skilled in the art may clearly understand that the foregoing method embodiments may be implemented by using software and a required universal hardware platform, or certainly may be implemented by using hardware. However, in many cases, the former is a better implementation. Based on such an understanding, the technical solutions of the present disclosure essentially or the part contributing to conventional technologies may be implemented in a form of a software product. The computer software product is stored in a storage medium (such as a ROM/RAM, a magnetic disk, or an optical disc) and includes several instructions for instructing a terminal device (which may be a mobile phone, a computer, a server, an air conditioner, or a network device) to perform the methods described in the embodiments of the present disclosure.

The embodiments of the present disclosure are described with reference to the accompanying drawings above. However, the present disclosure is not limited to the foregoing specific implementations. The foregoing specific implementations are merely exemplary, but are not limiting. A person of ordinary skill in the art may make many forms without departing from the objective and the scope of the claims of the present disclosure.

What is claimed is:

1. An object processing method, applied to a terminal device comprising a first screen and a second screen, the method comprising:
receiving a first input by a user, wherein the first input is a selection input for a target object in at least one first object displayed on the first screen;
displaying the target object on the second screen in response to the first input;
receiving a second input by the user for at least one second object displayed on the second screen, wherein the at least one second object comprises the target object; and
performing a target processing on the at least one second object in response to the second input.

2. The method according to claim 1, wherein content indicated by the at least one second object is any one of the following: an image, a video, audio, or a document; and
performing the target processing on the at least one second object comprises any one of the following:
sending the at least one second object to a target device; sending the content indicated by the at least one second object to a target device; deleting the at least one second object from the terminal device; deleting the content indicated by the at least one second object from the terminal device; changing a file format of the at least one second object; changing a file format of the content indicated by the at least one second object; changing a storage area of the at least one second object to a target storage area; changing a storage area of the content indicated by the at least one second object to a target storage area; merging the at least one second object into one object; or merging the content indicated by the at least one second object into one piece of content.

3. The method according to claim 1, wherein
content indicated by the at least one second object is an application program; and performing the target processing on the at least one second object comprises any one of the following: deleting the at least one second object from the terminal device; deleting the content indicated by the at least one second object from the terminal device; changing a storage area of the at least one second object to a target storage area; or changing a storage area of the content indicated by the at least one second object to a target storage area;
or
content indicated by the at least one second object is an installation package of an application program, and performing the target processing on the at least one second object comprises any one of the following: sending the content indicated by the at least one second object to a target device;
deleting the at least one second object from the terminal device; deleting the content indicated by the at least one second object from the terminal device; changing a file format of the content indicated by the at least one second object; changing a storage area of the at least one second object to a target storage area; changing a storage area of the content indicated by the at least one second object to a target storage area; or merging the content indicated by the at least one second object into one piece of content.

4. The method according to claim 1, wherein, before displaying the target object on the second screen, the method further comprises:
updating a display effect of the target object on the first screen to a target display effect.

5. The method according to claim 1, further comprising:
receiving a third input by the user on the first screen; and
in response to receiving the third input, updating the at least one first object displayed on the first screen to at least one third object.

6. A terminal device, comprising: a memory, a processor, and a computer program stored in the memory and executable by the processor, wherein the computer program, when executed by the processor, causes the processor to implement an object processing method, the method comprising:
receiving a first input by a user, wherein the first input is a selection input for a target object in at least one first object displayed on a first screen of the terminal device;
displaying the target object on a second screen of the terminal device in response to the first input;
receiving a second input by the user for at least one second object displayed on the second screen, wherein the at least one second object comprises the target object; and
performing a target processing on the at least one second object in response to the second input.

7. The terminal device according to claim 6, wherein content indicated by the at least one second object is any one of the following: an image, a video, audio, or a document; and
performing the target processing on the at least one second object comprises any one of the following:
sending the at least one second object to a target device; sending the content indicated by the at least one second object to a target device; deleting the at least one second object from the terminal device; deleting the content indicated by the at least one second object from the terminal device; changing a file format of the at least one second object; changing a file format of the content indicated by the at least one second object; changing a storage area of the at least one second object to a target storage area; changing a storage area of the content indicated by the at least one second object to a target storage area; merging the at least one second object into one object; or merging the content indicated by the at least one second object into one piece of content.

8. The terminal device according to claim 6, wherein
content indicated by the at least one second object is an application program; and performing the target processing on the at least one second object comprises any one of the following: deleting the at least one second object from the terminal device; deleting the content indicated by the at least one second object from the terminal device; changing a storage area of the at least one second object to a target storage area; or changing a storage area of the content indicated by the at least one second object to a target storage area;
or
content indicated by the at least one second object is an installation package of an application program, and performing the target processing on the at least one second object comprises any one of the following: sending the content indicated by the at least one second object to a target device;
deleting the at least one second object from the terminal device; deleting the content indicated by the at least one second object from the terminal device; changing a file format of the content indicated by the at least one second object; changing a storage area of the at least one second object to a target storage area; changing a storage area of the content indicated by the at least one second object to a target storage area; or merging the content indicated by the at least one second object into one piece of content.

9. The terminal device according to claim 6, wherein, before displaying the target object on the second screen, the method further comprises:
updating a display effect of the target object on the first screen to a target display effect.

10. The terminal device according to claim 6, wherein the method further comprises:
receiving a third input by the user on the first screen; and
in response to receiving the third input, updating the at least one first object displayed on the first screen to at least one third object.

11. A computer-readable storage medium, storing a computer program that, when executed by a processor, causes the processor to implement an object processing method, the method being applied to a terminal device comprising a first screen and a second screen, and the method comprising:
receiving a first input by a user, wherein the first input is a selection input for a target object in at least one first object displayed on the first screen;
displaying the target object on the second screen in response to the first input;
receiving a second input by the user for at least one second object displayed on the second screen, wherein the at least one second object comprises the target object; and
performing a target processing on the at least one second object in response to the second input.

12. The computer-readable storage medium according to claim 11, wherein content indicated by the at least one second object is any one of the following: an image, a video, audio, or a document; and
performing the target processing on the at least one second object comprises any one of the following:
sending the at least one second object to a target device; sending the content indicated by the at least one second object to a target device; deleting the at least one second object from the terminal device; deleting the content indicated by the at least one second object from the terminal device; changing a file format of the at least one second object; changing a file format of the content indicated by the at least one second object; changing a storage area of the at least one second object to a target storage area; changing a storage area of the content indicated by the at least one second object to a target storage area; merging the at least one second object into one object; or merging the content indicated by the at least one second object into one piece of content.

13. The computer-readable storage medium according to claim 11, wherein content indicated by the at least one second object is an application program; and performing the target processing on the at least one second object comprises any one of the following: deleting the at least one second object from the terminal device; deleting the content indicated by the at least one second object from the terminal device; changing a storage area of the at least one second object to a target storage area; or changing a storage area of the content indicated by the at least one second object to a target storage area;
or
content indicated by the at least one second object is an installation package of an application program, and performing the target processing on the at least one second object comprises any one of the following: sending the content indicated by the at least one second object to a target device;
deleting the at least one second object from the terminal device; deleting the content indicated by the at least one second object from the terminal device; changing a file format of the content indicated by the at least one second object; changing a storage area of the at least one second object to a target storage area; changing a storage area of the content indicated by the at least one second object to a target storage area; or merging the content indicated by the at least one second object into one piece of content.

14. The computer-readable storage medium according to claim 11, wherein, before displaying the target object on the second screen, the method further comprises:
updating a display effect of the target object on the first screen to a target display effect.

15. The computer-readable storage medium according to claim 11, wherein the method further comprises:
receiving a third input by the user on the first screen; and
in response to receiving the third input, updating the at least one first object displayed on the first screen to at least one third object.
